(19) United States
(12) Patent Application Publication
(10) Pub. No.: US 2014/0216067 A1
(43) Pub. Date: Aug. 7, 2014

(54) METHOD AND APPARATUS FOR HEATING A LIQUEFIED STREAM

(71) Applicant: SHELL INTERNATIONALE RESEARCH MAATSCHAPPIJ B.V., The Hague (NL)

(72) Inventors: Roderick Kempes, Calgary (CA); Robert Lansink, Rotterdam (NL); Gregory Martin Parry Perkins, Brisbane (AU); Leendert Johannes Arie Zoetemeijer, Amsterdam (NL)

(21) Appl. No.: 14/241,343

(22) PCT Filed: Jun. 12, 2013
(86) PCT No.: PCT/EP2013/062181

§ 371 Date: Feb. 26, 2014

(30) Foreign Application Priority Data
Jun. 12, 2012 (EP) 12171678.1

(51) Int. Cl. F17C 9/02; F28D 15/02

(52) U.S. Cl. CPC F17C 9/02; F28D 15/0266; F17C 2221/033; F17C 2223/013; F17C 2225/0123; F17C 2227/0309; F17C 2265/05
USPC 62/50.2; 165/104.22

(57) ABSTRACT

In a closed circuit a heat transfer fluid is cycled from a first heat transfer zone to a second heat transfer zone via a downcomer, all arranged in an ambient. The first heat transfer zone, housed inside a first box, comprises a first heat transfer surface across which the liquefied stream is brought in a first indirect heat exchanging contact with the heat transfer fluid. The heat transfer fluid is allowed to condense, and a part of the condensed portion of the heat transfer fluid is allowed to accumulate within the first box thereby forming a liquid layer of the heat transfer fluid. Liquid is drawn from the liquid layer and passed through the downcomer to the second heat transfer zone. The second heat transfer zone comprises a second heat transfer surface across which the heat transfer fluid is brought in a second indirect heat exchanging contact with the ambient.

### PRIORITY CLAIM

The present application, which is a 371 application of PCT/EP2013/062181, filed Jun. 12, 2013, claims priority from European Application EP 12171678.1, filed Jun. 12, 2012, each of which are hereby incorporated by reference in their entirety.

The present invention relates to a method and an apparatus for heating a liquefied stream.

A liquefied stream in the present context has a temperature below the temperature of the ambient. Preferably, the temperature of the liquefied stream is on or below the bubble point of the liquefied stream at a pressure of less than 2 bar absolute, such as to keep it in a liquid phase at such a pressure. An example of a liquefied stream in the industry that requires heating is liquefied natural gas (LNG).

Natural gas is a useful fuel source. However, it is often produced a relative large distance away from market. In such cases it may be desirable to liquefy natural gas in an LNG plant at or near the source of a natural gas stream. In the form of LNG natural gas can be stored and transported over long distances more readily than in gaseous form, because it occupies a smaller volume and does not need to be stored at high pressure.

LNG is generally revaporized before it is used as a fuel. In order to revaporize the LNG heat may added to the LNG. Before adding the heat, the LNG is often pressurized to meet customer requirements. Depending on gas grid specifications or requirements desired by a customer, the composition may also be changed if desired, for instance by adding a quantity of nitrogen and/or extracting some of the C₂-C₄ content. The revaporized natural gas product may then be sold to a customer, suitably via the gas grid.

Patent application publication US2010/0000233 describes an apparatus and method for heating a liquefied stream. In this apparatus and method, a heat transfer fluid is cycled, in a closed circuit, between a first heat transfer zone wherein heat is transferred from the heat transfer fluid to the liquefied stream that is to be heated, and a second heat transfer zone wherein heat is transferred from ambient air to the heat transfer fluid. The heat transfer fluid is condensed in the first heat transfer zone and heated in the second heat transfer zone. The heat transfer fluid is cycled using gravitational force exerted on the heat transfer fluid being cycled in the closed circuit.

Patent application publication US2006/0242969 discloses another system and method for vaporizing a cryogenic liquid using a naturally circulating intermediate refrigerant. The cryogenic liquid is passed through tube bundles in a first heat exchanger, which tube bundles are vertically arranged inside the first heat exchanger. The refrigerant is passed from a second heat exchanger into a first heat exchanger via a refrigerant vapour inlet and a riser that traverses upwardly through the first heat exchanger side by side to the tube bundles for the cryogenic fluid. The refrigerant vapour is discharged into a space for refrigerant vapour near the top of the first heat exchanger. The refrigerant vapour is condensed into a liquid intermediate refrigerant material by heat exchanging with the cryogenic fluid in the tube bundles, whereby liquid intermediate refrigerant material accumulates at the bottom of the first heat exchanger and is passed to the second heat exchanger.

It is anticipated that circulation of the heat transfer fluid may be disrupted during normal operation of the apparatuses and methods as described in US2010/0000233 and US2006/0242969.

In accordance with a first aspect of the present invention, there is provided a method of heating a liquefied stream, comprising:

passing the liquefied stream that is to be heated through a first heat transfer zone comprising a first box in the form of a shell that contains a heat transfer fluid, in indirect heat exchanging contact with the heat transfer fluid across a first heat transfer surface arranged inside the first box, whereby heat transfers from the heat transfer fluid to the liquefied stream, thereby condensing at least part of the heat transfer fluid to form a condensed portion;

allowing accumulation of a part of the condensed portion within the first box thereby forming a liquid layer of the heat transfer fluid in the liquid phase within the first box, wherein above the liquid layer of the heat transfer fluid in liquid phase within the first box is a vapour zone, whereby the first heat transfer surface is arranged within the vapour zone in the first box;

cycling the heat transfer fluid in a closed circuit from the first box via at least a downcomer to a second heat transfer zone and back to the first heat transfer zone, all arranged in an ambient;

wherein said cycling of the heat transfer fluid comprises drawing liquid from the liquid layer in the first box and passing said liquid from the liquid layer in liquid phase through the downcomer to the second heat transfer zone, and passing the heat transfer fluid through the second heat transfer zone to the first heat transfer zone, whereby in the second heat transfer zone indirectly heat exchanging with the ambient thereby passing heat from the ambient to the heat transfer fluid and vaporizing the heat transfer fluid, wherein the second heat transfer zone discharges into the vapour zone in first box at a location that is gravitationally above the liquid layer, wherein the heat transfer fluid from the second heat transfer zone passes through open ends of one or more riser end pieces as the heat transfer fluid is being discharged from the second heat transfer zone into the first box, which one or more riser end pieces traverse through the liquid layer into the vapour zone, whereby the open ends of the riser end pieces are located gravitationally lower than the first heat exchange surface.

In accordance with a second aspect of the invention, there is provided an apparatus for heating a liquefied stream, comprising a closed circuit for cycling a heat transfer fluid, the closed circuit comprising a first heat transfer zone, a second heat transfer zone, and a downcomer, all arranged in an ambient, wherein the first heat transfer zone comprises a first box in the form of a shell that contains the heat transfer fluid, wherein a first heat transfer surface is arranged inside the first box, across which first heat transfer surface a first indirect heat exchanging contact is established between a liquefied stream that is to be heated and the heat transfer fluid, said apparatus further comprising a liquid layer of the heat transfer fluid in the liquid within the first box wherein above the liquid layer of the heat transfer fluid in liquid phase within the first box is a vapour zone, whereby the first heat transfer surface is arranged within the vapour zone in the first box, wherein the second heat transfer zone is located gravitationally lower than the first heat transfer zone and where the second heat transfer zone comprises a second heat transfer surface across which the heat transfer fluid is brought in a second indirect heat exchanging contact with the ambient, and wherein the downcomer fluidly connects the first heat transfer zone with the second heat transfer zone, whereby an interface between the downcomer and the first box is located submerged under the liquid layer of the heat transfer fluid in the first box, wherein the second heat transfer zone comprises at least one riser tube fluidly connected to the first heat transfer zone, which at least one riser tube comprises a riser end piece fluidly connected to the riser tube and traversing through the liquid layer into the vapour zone, wherein an open end of the at least one riser tube is located gravitationally lower than the first heat exchange surface.

The invention will be further illustrated hereinafter by way of example only and with reference to the non-limiting drawing in which;

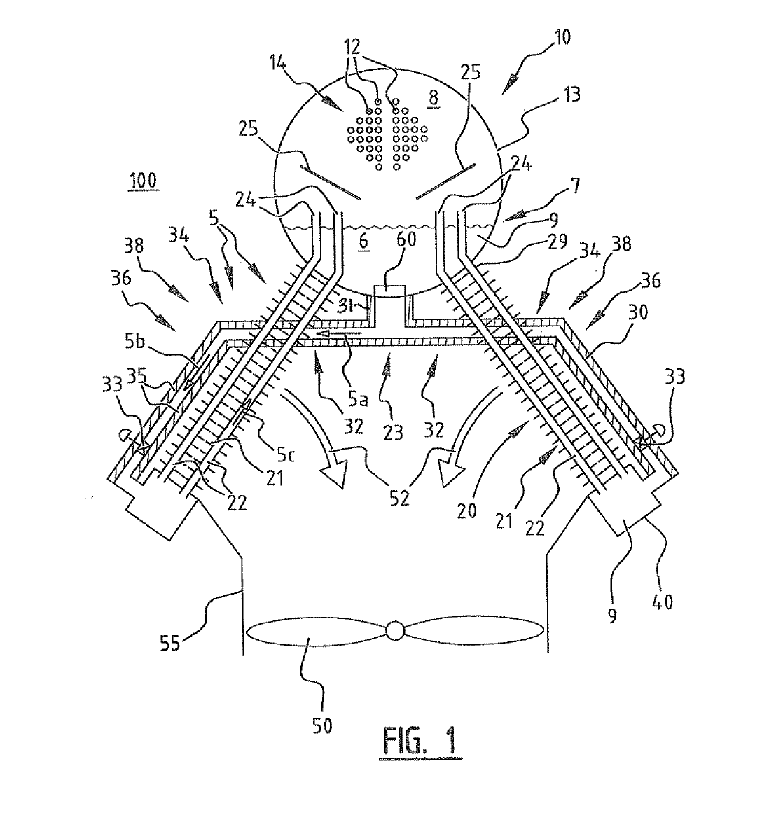

FIG. 1 represents a transverse cross section of a heater in which the invention is embodied;

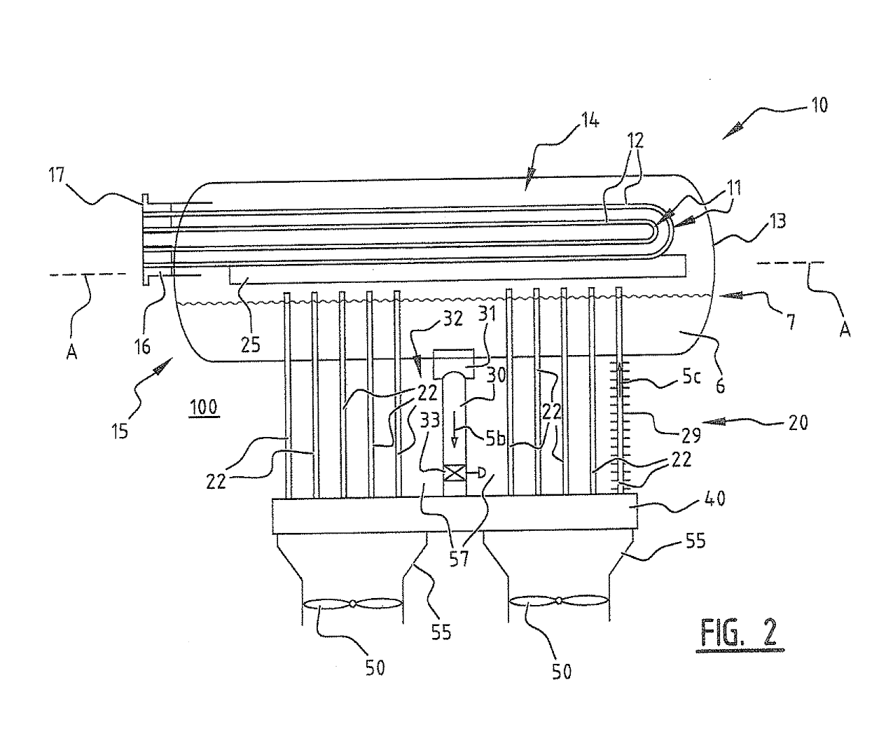

FIG. 2 represents a longitudinal section of the heater of FIG. 1;

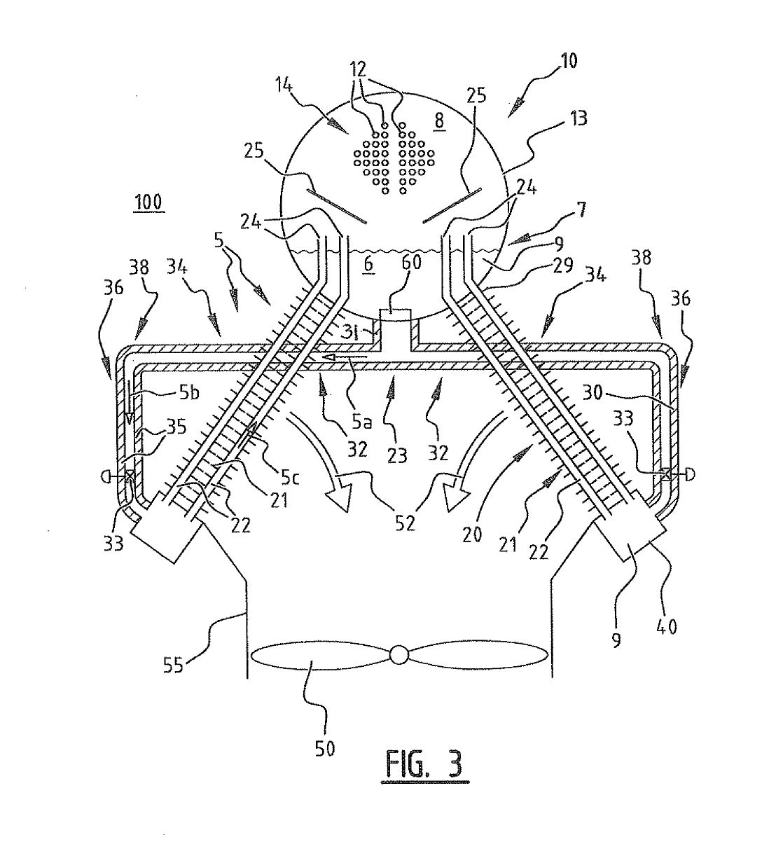

FIG. 3 represents a transverse cross section of a heater in which the invention is embodied.

For the purpose of this description, a single reference number will be assigned to a line as well as a stream carried in that line. Same reference numbers refer to similar components. The person skilled in the art will readily understand that, while the invention is illustrated making reference to one or more a specific combinations of features and measures, many of those features and measures are functionally independent from other features and measures such that they can be equally or similarly applied independently in other embodiments or combinations.

The present description generally discloses a method of heating a liquefied stream, comprising:

passing the liquefied stream that is to be heated through a first heat transfer zone comprising a first box in the form of a shell that contains a heat transfer fluid, in indirect heat exchanging contact with the heat transfer fluid across a first heat transfer surface arranged inside the first box, whereby heat transfers from the heat transfer fluid to the liquefied stream, thereby condensing at least part of the heat transfer fluid to form a condensed portion;

allowing accumulation of a part of the condensed portion within the first box thereby forming a liquid layer of the heat transfer fluid in the liquid phase within the first box;

cycling the heat transfer fluid in a closed circuit from the first box via at least a downcomer to a second heat transfer zone and back to the first heat transfer zone, all arranged in an ambient;

wherein said cycling of the heat transfer fluid comprises drawing liquid from the liquid layer in the first box and passing said liquid from the liquid layer in liquid phase through the downcomer to the second heat transfer zone, and passing the heat transfer fluid through the second heat transfer zone to the first heat transfer zone, whereby in the second heat transfer zone indirectly heat exchanging with the ambient thereby passing heat from the ambient to the heat transfer fluid and vaporizing the heat transfer fluid.

Furthermore, the present description generally discloses an apparatus for heating a liquefied stream, comprising a closed circuit for cycling a heat transfer fluid, the closed circuit comprising a first heat transfer zone, a second heat transfer zone, and a downcomer, all arranged in an ambient, wherein the first heat transfer zone comprises a first box in the form of a shell that contains the heat transfer fluid, wherein a first heat transfer surface is arranged inside the first box, across which first heat transfer surface a first indirect heat exchanging contact is established between a liquefied stream that is to be heated and the heat transfer fluid, wherein the second heat transfer zone is located gravitationally lower than the first heat transfer zone and where the second heat transfer zone comprises a second heat transfer surface across which the heat transfer fluid is brought in a second indirect heat exchanging contact with the ambient, and wherein the downcomer fluidly connects the first heat transfer zone with the second heat transfer zone, further comprising a liquid layer of the heat transfer fluid in the liquid within the first box, whereby an interface between the downcomer and the first box is located submerged under the liquid layer of the heat transfer fluid in the first box.

Ways to further improve circulation of the heat transfer fluid through the closed circuit will be described below. It has been conceived that circulation of the heat transfer fluid can be impeded by the return flow of vapour of the heat transfer fluid though a vapour return riser. It is presently proposed to arrange the open ends of the riser end pieces gravitationally lower than the first heat transfer surface. Herewith it is avoided that vapour of the vaporized heat transfer fluid is confined in the riser end pieces for longer than necessary. The vapour can reach the first heat exchange surface by further rising through a vapour zone of the first heat transfer zone in which the first heat transfer surface is arranged as well. The vapour can suffer less from flow resistance in the vapour zone compared to flowing within the confines of the riser end pieces. The open ends of the riser end pieces are preferably located above a nominal liquid level of the liquid layer of the heat transfer fluid in the first box.

It has been further conceived that the presence of vapour in the downcomer may disturb the circulation of the heat transfer fluid in the closed cycle.

In the presently proposed method and apparatus, only liquid from the liquid layer consisting of heat transfer fluid in the liquid phase that has accumulated in the first box is passed in liquid phase through the downcomer to the second heat transfer zone. The liquid layer is formed by condensing the heat transfer fluid by indirect heat exchange with the liquefied stream that is to be heated and allowing accumulation of a part of the condensed portion of the within the first box.

As the interface between the downcomer and the first box is located submerged under the liquid layer of the heat transfer fluid in the first box, passage of vapour from the first box into the downcomer is effectively blocked. As a result, the circulation of the heat transfer fluid through the closed circuit is not disturbed by vapour streaming from the first box into the downcomer.

Especially the combination of avoiding vapour passing from the first box into the downcomer and reducing the barrier flowing into the first box that is felt by the vapour generated in the second heat transfer zone is particularly effective to enhance the natural circulation of the heat transfer fluid.

It has been found that the circulation of the heat transfer fluid through the closed circuit may be hampered, possibly to an extent that there is no circulation at all, when there is even a small amount of vapour generation in the downcomer. Hence, it is preferred that no vapour is admitted and/or generated in the downcomer.

In a preferred embodiment, the downcomer is thermally insulated from the ambient and/or the liquid from the liquid layer of heat transfer fluid in liquid phase passes downward through the downcomer to the second heat transfer zone thermally insulated from the ambient.

Herewith, vaporization of the condensed portion of the heat transfer fluid being conveyed downward through the downcomer is avoided. As a result, circulation of the heat transfer fluid through the closed circuit will not be disturbed by vapour generation in the downcomer.

There is no absolute requirement for the amount of insulation. The amount of insulation is recommended to be sufficient to accomplish that the heat in leak into the heat transfer fluid as it passes through the downcomer, due to the temperature differential between the heat transfer fluid inside the downcomer and the outside of the downcomer (influenced by, for instance, the ambient air temperature and the absorption of solar radiation) will not cause any vaporization of the heat transfer fluid inside the downcomer. The amount of insulation will therefore depend on the specific design configuration (including e.g. the vertical height of the downcomer, the residence time of the heat transfer fluid in the downcomer, the composition of the heat transfer fluid, and the actual operating pressure of the heat transfer fluid) which could be different from design to design. It is therefore recommended that the effect of heat in leak is evaluated on a case by case basis. However, as a guideline, insulation to meet an R-value of 0.3 m²K/W or higher is a suggested example.

The circulation of the heat transfer fluid is even more helped if the heat transfer fluid rises upward during said vaporizing of the heat transfer fluid in the second heat transfer zone, because the vapour will help to drive any remaining liquid upward. Preferably, the second heat transfer zone comprises at least one riser tube fluidly connected to the first heat transfer zone.

Clearly, the downcomer and/or the at least one riser tube may suitably have a circular cross section (transverse to their respective flow directions). However, a non circular cross section may be applied if desired for either one of the downcomer or the at least one riser tube, or both.

Typically the circulation can be maintained by gravity only, without the use of a pump, particularly if condensation of the heat transfer fluid takes place in the first heat transfer zone and vaporization of the heat transfer fluid in the second heat transfer zone.

In one group of embodiments, the downcomer and the second heat transfer zone are fluidly connected with each other via a distribution header whereby the second heat transfer zone comprises a plurality of riser tubes fluidly connecting the distribution header with the first heat transfer zone. The plurality of riser tubes may preferably be arranged in a row to form a row of riser tubes. The condensed portion leaving the downcomer may be distributed over the plurality of riser tubes wherein said rising upward takes place. This is one suitable way of achieving that the cumulative area that is exposed to the ambient for indirect heat exchange in the second heat transfer zone can be larger than the area of the downcomer that is exposed to the ambient. Another way, which may be used in addition to or instead of the plurality of riser tubes is to apply heat contact improvers such as fins protruding outwardly from the at least one riser tube into the ambient.

The difference in heat exchange area in the second heat transfer zone as compared to the downcomer further drives the circulation of the heat transfer fluid as the vaporization in the second heat transfer zone improves as a result of a higher heat transfer rate from the ambient to the heat transfer fluid.

The circulation of the heat transfer fluid through the closed circuit is hampered; possibly to an extent that there is no circulation at all, when there is even a small amount of vapour generation in the downcomer. Hence, it is preferred that no vapour at all is generated and/or admitted in the downcomer.

Preferably, not only the downcomer but also the optional distribution header is thermally insulated from the ambient. This further ensures that no vaporization of the heat transfer fluid takes place prior to the fluid entering inside the second heat transfer zone, such as for example in the riser tubes.

Furthermore, the distribution header is preferably arranged gravitationally lower than the second heat transfer zone. Herewith it is achieved that vapour that is generated in the at least one riser tube cannot find its way into the downcomer, because any vapour being generated within the at least one riser tube is expected to flow upward.

A vortex breaker may preferably be provided between the first heat transfer zone and the downcomer. Such vortex breaker may facilitate reduction and/or avoidance of entrainment of any vapour with the liquid of the condensed heat transfer fluid into the downcomer.

One non-limiting example of an apparatus for heating a liquefied stream is shown in FIGS. 1 and 2, in the form of a heater of liquefied natural gas. This heater may also be used as a vaporizer of liquefied natural gas. FIG. 1 shows a transverse cross section, and FIG. 2 a longitudinal section of the apparatus.

The apparatus comprises a first heat transfer zone 10, a second heat transfer zone 20, a downcomer 30, and a closed circuit 5 for cycling (indicated by arrows 5a, 5b, 5c) a heat transfer fluid 9, all arranged in an ambient 100. Typically, the ambient 100 consists of air. The first heat transfer zone 10, the second heat transfer zone 20 and the downcomer 30 all form part of the closed circuit 5. The second heat transfer zone 20 may comprise at least one riser tube 22, in which case the heat transfer fluid 9 may be conveyed within the at least one riser tube 22 while the ambient is in contact with the outside of the at least one riser tube 22. Optionally, the closed circuit 5 may comprise a distribution header 40 to fluidly connect the downcomer 30 and the second heat transfer zone 20 with each other. Such a distribution header 40 may be useful if the second heat transfer zone 20 comprises a plurality of riser tubes 22. The at least one riser tube 22, or plurality thereof, is fluidly connected to the first heat transfer zone 10.

The optional distribution header 40 is preferably arranged gravitationally lower than the second heat transfer zone 40.

The first heat transfer zone 10 may comprise a first box 13, for instance in the form of a shell, which contains the heat transfer fluid 9. The first heat transfer zone 10 comprises a first heat transfer surface 11, which may be arranged within the first box 13. The shell of the first box 13 may be an elongated body, for instance in the form of an essentially cylindrical drum, provided with suitable covers on the front and rear ends. Outwardly curved shell covers may be a suitable option. The shell may suitably stretch longitudinally along a main axis A.

The first heat transfer surface 11 functions to bring a liquefied stream that is to be heated in a first indirect heat exchanging contact with the heat transfer fluid 9, whereby the heat transfer fluid 9 is located on the opposing side of the first heat exchange surface 11 which is the side of the first heat exchange surface that faces away from the liquefied stream that is to be heated. Optionally, the first heat transfer surface 11 may be formed out of one or more tubes 12, optionally arranged in a tube bundle 14. In such a case, the liquefied stream that is to be heated may be conveyed within the one or more tubes 12 while the heat transfer fluid is in contact with the outside of the one or more tubes 12.

Analogue to shell and tube heat exchangers, the tubes 12 may be arranged single pass or multi pass, with any suitable stationary head on the front end and/or rear end if necessary.

The second heat transfer zone 20 is located gravitationally lower than the first heat transfer zone 10. The second heat transfer zone 20 comprises a second heat transfer surface 21, across which the heat transfer fluid 9 is brought in a second indirect heat exchanging contact with the ambient 100. If the second heat transfer surface 21 comprises one or more riser tubes 22, the heat transfer fluid 9 may be conveyed within the one or more riser tubes 22 while the ambient is in contact with the outside of the one or more riser tubes 22. The outside surface of the one or more riser tubes 22 may conveniently be provided with heat transfer improvers such as area-enlargers. These may be in the form of fins 29, grooves (not shown) or other suitable means. Please note that fins 29 may be present on all of the riser tubes 22, but for reason of clarity they have only been drawn on one of the riser tubes 22 in FIG. 2.

The downcomer 30 fluidly connects the first heat transfer zone 10 with the second heat transfer zone 20. In more detail, the downcomer 30 has an upstream end for allowing passage of the heat transfer fluid from the first heat transfer zone 10 into the downcomer 30, and a downstream end for allowing passage of the heat transfer fluid 9 from the downcomer 30 towards the second heat transfer zone 20. The downcomer 30 is thermally insulated from the ambient 100. This is schematically shown in FIG. 1 by an insulation layer 35 applied to an external surface of the downcomer 30. The insulation layer 35 may be formed of and/or comprise any suitable pipe or duct insulating material and it may optionally be offering protection against under-insulation corrosion. Suitably the insulation layer comprises a foam material, preferably a closed-cell foam material to avoid percolation condense. One example is Armaflex™ pipe insulation optionally provided with an Armachek-R™ cladding, both commercially obtainable from Armacell UK Ltd. Armachek-R™ is a high-density rubber-based cover lining.

A fan 50 (one or multiple) may be positioned relative to the second heat transfer zone 20 to increase circulation of ambient air along the second heat transfer zone 20, as indicated in FIG. 1 by arrows 52. Herewith the heat transfer rate in the second indirect heat exchanging contact may be increased. Preferably the fan is housed in an air duct 55 arranged to guide the ambient air from the fan 20 to the second heat transfer zone 20 or vice versa. In a preferred embodiment, the ambient air circulates generally downwardly from the second heat transfer zone 20 into the air duct 55 and to the fan 50.

The downcomer 30 may take various forms. For instance, as non-limiting example, the downcomer may comprise a common section 31 which fluidly connects the first heat transfer zone 10 with a T-junction 23 where the heat transfer fluid 9 is divided over two branches 32. The two branches 32 may be connected to one distribution header 40 each, whereby each of these distribution headers are separate in the sense that the heat transfer fluid 9 inside one of these distribution headers cannot flow to the other except via the T-junction 23 or via the first heat transfer zone 10. The T-junction 23 may be located gravitationally below the first box 13.

A valve 33, for instance in the form of a butterfly valve, may optionally be provided in the downcomer 30 and/or in each of the branches 32 of the downcomer 30. This may be a manually operated valve. With this valve the circulation of the heat transfer fluid through the closed cycle can be trimmed; in case of a large vertical differential in the downcomer, there could be substantial effect of the liquid static head on the bubble point (boiling point) which can be counteracted by creating a frictional pressure drop through the valve.

If the first box 13 is provided in the form of an elongated hull stretching along main axis A, the branches 32 may suitably extend transverse to the direction of the main axis A. The riser tubes 22 of the plurality of riser tubes may be arranged distributed over the distribution header 40 in a main direction that is parallel to the main axis A. In this case, each distribution header 40 suitably also has an elongate shape essentially in the same direction as the main axis A, in which case the riser tubes 22 may be suitably configured in a plane that is parallel to the main axis A. In a particularly advantageous embodiment, the riser tubes are arranged over a two-dimensional pattern both in the main direction as well as in a transverse direction extending transversely relative to the main direction.

The number of riser tubes 22 that fluidly connect a selected distribution header 40 with the first heat transfer zone 10 is larger than the number of downcomers (and/or number of branches of a single downcomer) that fluidly connect the first heat transfer zone 10 with that same distribution header 40. For instance, in one example there are 84 riser tubes 22 arranged between the first heat transfer zone 10 and a single distribution header 40 which is supplied with the heat transfer fluid 9 by only a single branch 32 of a single downcomer 30. The plurality of riser tubes 22 may suitably be arranged divided in two subsets, a first subset being arranged on one side of the downcomer 30 (or branch 32) that connects the distribution header 40 with the first heat transfer zone 10, while a second subset of which is arranged on the other side of the downcomer 30 (or branch 32). An air seal 57 may be located between the downcomer 30 (or branch 32) and each of the subsets of riser tubes 22, on either side of the downcomer 30, to avoid that air bypasses the second heat transfer zone though the gap between the downcomer 30 and each of the subsets of riser tubes 22.

During normal operation, the heater comprises a liquid layer 6 of the heat transfer fluid 9 in the liquid phase accumulated within the first heat transfer zone 10. Above the liquid layer 6 of the heat transfer fluid 9 in liquid phase within the first heat transfer zone 10 is a vapour zone 8. The nominal liquid level 7 is defined as the level of the interface between liquid layer 6 and the vapour zone 8 during normal operation of the heater.

The first heat exchange surface 11 is preferably arranged within the vapour zone 8 in the first heat transfer zone 10, above the nominal liquid level 7. Herewith the heat transfer in the first heat exchanging contact between the liquefied stream that is to be heated and the heat transfer fluid 9 can most effectively benefit from the heat of condensation of the heat transfer fluid 9 that is available within in the vapour zone 8.

The interface between the first heat transfer zone 10 and the downcomer 30 may be formed by a through opening in the shell of the first box 13. The interface is preferably located gravitationally lower than a nominal liquid level 7 of the heat transfer fluid 9 within the first box 13.

The second heat transfer zone 20 preferably discharges into the first heat transfer zone 10 at a location that is gravitationally above the nominal liquid level 7. This way the heat transfer fluid 9 can be cycled back from the second heat transfer zone 20 to the first heat transfer zone 10 while bypassing the layer of liquid phase of the heat exchange fluid 9 that has accumulated in the first box 13. This may be accomplished as illustrated in FIGS. 1 and 2 by riser end pieces 24 fluidly connected to the riser tubes and extending between the riser tubes 22 and a vapour zone 8 inside the first heat transfer zone 10 above the nominal liquid level 7, which riser end pieces 24 traverse the liquid layer 6.

The open ends of the riser end pieces 24 are located gravitationally lower than the first heat exchange surface 11. Herewith it is avoided that vapour of the vaporized heat transfer fluid is confined in the riser end pieces 24 for longer than necessary. The vapour can reach the first heat exchange surface 11 by further rising in the vapour zone 8 of the first heat transfer zone 10 where it can suffer less from flow resistance than within the confines of the riser end pieces 24. Preferably, the open ends of the riser end pieces 24 are located above the nominal liquid level 7.

Optionally, one or more liquid diversion means may be provided to shield the riser end pieces 24 from condensed heat exchange fluid 9 falling down from the first heat exchange surface 11 during operation. Such liquid diversion means may be embodied in many ways, one of which is illustrated in FIGS. 1 and 2 in the form of a weir plate 25 arranged between the first heat exchange surface 11 (e.g. provided on the tubes 12) and the open ends of the riser end pieces 24. The illustrated weir plate 25 is arranged parallel to main axis A and inclined about 30° from the horizontal to guide the condensed heat transfer fluid 9 towards the longitudinal center of the box 13. Other arrangements are possible, such as a vertical arrangement of the weir plates whereby the first heat exchange surfaces are on one side of the vertical plane in which the weir plate is arranged, and the riser end pieces are on the other side of the vertical plane, and/or such as bubble caps on the riser end pieces similar to those used in distillation trays. Combinations of these and/or other ways may also be employed.

A vortex breaker 60 may be a provided at the upstream end of the downcomer 30, for instance at or near the interface between the first heat transfer zone 10 and the downcomer 30. In the embodiment of FIGS. 1 and 2, the vortex breaker 60 is suitably near the interface between the first heat transfer zone 10 and the common section 31 of the downcomer 30. A vortex breaker is a known device applied to avoid occurrence of a vortex swirl in the liquid layer 6, as this may entrap vapour in the liquid flowing into the downcomer 30.

Although not so indicated in FIGS. 1 and 2, the distribution header 40 may be thermally insulated from the ambient—for instance in the same way as the downcomer 30. The thermal insulation of the distribution header 40 may comprise a layer of an insulating material on the distribution header 40, preferably the same insulating material as used for the downcomer 30.

As one example, referring now mainly to FIG. 2, there is shown a two-pass tube bundle 14 in the form of a U-tube bundle. However, the invention is not limited to this type of bundle. The shell cover on the front end 15 of this particular shell is provided with a cover nozzle 16 comprising a head flange 17 to which any type of suitable, preferably stationary, head and tube sheet can be mounted. One or more pass partitions may be provided in the head for multi-pass tube bundles. Typically, a single pass partition suffices for a two-pass tube bundle. The invention is not limited to this particular type of cover nozzle 16; for instance a cover nozzle with a fixed tube sheet may be selected, instead. A suitable head is an integral bonnet head or a head with removable cover. The tubes may be secured in relative position with each other by one or more transverse baffles or support plates. A mechanical construction inside the first box 13 may be provided to support the tube bundle, for instance in the form of a structure that is positioned below the tube bundle. The tube ends may be secured in the tube sheet.

Optionally the rear end may also be provided with a cover nozzle, so that, instead of the U-tube, a tube sheet may be provided at the rear end as well.

Although not a requirement of the present invention, in the embodiments described above, each branch 32 of the downcomer 30 has a transverse portion 34 and a downward portion 36 fluidly connected to each other via a connecting elbow portion 38. A first nominal flow direction of the heat transfer fluid 9 from the first heat transfer zone 10 to the second heat transfer zone 20 in the transverse portion 34 (indicated by arrow 5a) is less vertically directed than a second nominal flow direction of the heat transfer fluid 9 from the first heat transfer zone 10 to the second heat transfer zone 20 in the downward portion 36 (the latter nominal flow direction is indicated by 5b). Preferably, the first nominal flow direction (5a) is deviated within a range of from 60° to 90° from the vertical direction, more preferably within a range of from 80° to 90° from the vertical direction. Preferably, the second nominal flow direction (5b) is deviated within a range of from 0° to 30° from the vertical direction, more preferably within a range of from 0° to 10° from the vertical direction. It has surprisingly been found that the sensitivity of the circulation of the heat exchange fluid 9 through the closed circuit to the presence of vapour in the downcomer is very sensitive at angles of inclination in the range of between 30° and 60°. Without intending to be limited by the theory, it is currently understood that the pressure gradient in the downcomer is particularly sensitive to presence of vapour within this inclination range, whereby the two-phase flow regime is stratified wavy.

By arranging the transverse portion 34 such that the first nominal flow direction (5a) is deviated within a range of from 60° to 90° from the vertical direction, more preferably within a range of from 80° to 90° from the vertical direction, and arranging the downward portion 36 such that the second nominal flow direction (5b) is deviated within a range of from 0° to 30° from the vertical direction, more preferably within a range of from 0° to 10° from the vertical direction, an average flow direction through all portions of the downcomer 30 of within the inclination range of between 30° and 60° can be achieved without the need for the heat transfer fluid 9 to flow through the downcomer 30 at an angle within this inclination range except for a relatively small duration within the connecting elbow portion 38. In such embodiments, the connecting elbow portion 38 is defined as the part of the downcomer between the transverse portion 34 and the downward portion 36 where the flow direction is at an inclination between 30° and 60°.

The second heat transfer surface 21 of riser tubes 22 may be located in a generally straight portion of the riser tubes 22. The generally straight portion of the riser tubes 22 may be at any desired angle, including an angle within the inclination range of between 30° and 60°. The heat transfer fluid 9 is cycled in the direction along arrow 5c in the generally straight portion of the riser tubes 22 deviating by an angle of about 30° from vertical. Each branch 32 of the downcomer 30 runs approximately parallel to the riser tubes 22 over the downward portion 36 of each branch 32.

However, in one group of alternative embodiments at least the downward portion 36 of each branch 32 in the downcomer 30 is positioned with a more vertical flow direction, for example deviating from the vertical direction by an angle of less than 30°. Referring now to FIG. 3, there is schematically shown a cross section similar to FIG. 1, of an example of such an alternative embodiment. The alternative embodiment has many of the same features as described above. One difference to be highlighted is that the flow direction along arrow 5b of the heat transfer fluid 9 in the downward portion 36 of each branch 32 deviates less from vertical than the flow direction along arrow 5c of the heat transfer fluid 9 in the generally straight portion of the riser tubes 22. Preferably, the flow direction along arrow 5b in the downward portion 36 of each branch 32 stretches within about 10° from vertical. It has been found that pressure gradient in a downcomer branch 32 orientated this way (i.e. vertical or near-vertical down flow) is less sensitive to vapour generation than when it is orientated at an angle of inclination between 10° and 60° from vertical.

Clearly, these considerations may be optionally applied as an additional safeguard, because if the generation in or access of vapour into the downcomer is 100% effective there will typically be no two-phase flow inside the downcomer.

The connecting elbow portion 38, when viewed in a vertical projection on a horizontal plane, is preferably located external to the first box 13, while in this projection the main axis A may be located within the first box 13. With such a configuration, the downward portion 36 of the downcomer 30 can be horizontally displaced (when viewed in the described projection) from the first box 13. Consequently, the circulation of ambient air (52) in vertical direction needs to be hindered less by the first box 13 in which the first heat transfer zone 10 is housed, because the ambient air can circulate in a vertical direction between the connecting elbow 38 and the first box 13. In such embodiments, the second heat transfer 21 surface is preferably arranged, at least for a part of the second heat transfer surface 21, in the space between the connecting elbow 38 and the first box 13 when seen in the projection on the horizontal plane.

As drawn in FIG. 1, the downward portion 36 of the downcomer is arranged parallel to the at least one riser tube 22. The invention also encompasses embodiments wherein the downward portion of each branch of the downcomer 30 is arranged in the same plane as the riser tubes 22. Furthermore, instead of having the junction 23 and the transverse portions 34, each downcomer may be directly connected via a nozzle from the first box at a location in the same plane as the risers, such that the downcomer and risers are in the same plane without the need for a transverse portion. This will also allow having two independent circulation loops (left vs. right leg, each with an individual downcomer).

In operation, the apparatus according to any of the embodiments as described above is suitable for use in a method of heating a liquefied stream. A prime example of a liquefied stream to be heated is an LNG stream. The resulting heated stream may be a revaporized natural gas stream (produced by heating and vaporizing liquefied natural gas) may be distributed via a pipe network of a natural gas grid.

LNG is usually a mixture of primarily methane, together with a relatively low (e.g. less than 25 mol. %) amount of ethane, propane and butanes (C₂-C₄) with trace quantities of heavier hydrocarbons (C₅+) including pentanes and possibly some non-hydrocarbon components (typically less than 2 mol. %) including for instance nitrogen, water, carbon dioxide, and/or hydrogen disulfide. The temperature of LNG is low enough to keep it in liquid phase at a pressure of less than 2 bar absolute. Such a mixture can be derived from natural gas.

A suitable heat transfer fluid for accomplishing the heating of LNG is CO₂. The heat transfer fluid 9 is cycled in the closed circuit 5. During said cycling the heat transfer fluid 9 undergoes a first phase transition from vapour to liquid phase in the first heat transfer zone 10, and second phase transition from liquid to vapour phase in the second heat transfer zone 20.

According to a particularly preferred embodiment the heat transfer fluid comprises at least 90 mol % CO₂, more preferably it consists for 100 mol % or about 100 mol % of CO₂. An important advantage of CO2 when used for heating LNG is that—if a leak occurs in the closed circuit 5 for the heat transfer fluid 9—the CO₂ will solidify at the leakage point thereby reducing or even blocking the leakage point. Moreover, CO₂ doesn't result in flammable mixtures if it would leak from the closed circuit. The boiling point of CO₂ is in the range of from −5.8 to −0.1° C. at pressures in the range of from 30 to 35 bar.

In the method of heating the liquefied stream, the liquefied stream that is to be heated is passed through the first heat transfer zone 10, in indirect heat exchanging contact with the heat transfer fluid 9, whereby heat is transferred from the heat transfer fluid 9 to the liquefied stream that passes through the first heat transfer zone 10. Thereby, at least part of the heat transfer fluid 9 is condensed to form a condensed portion. Preferably, the indirect heat exchanging takes place between the liquefied stream that is to be heated and the vapour of the heat transfer fluid 9 within the in the vapour zone 8.

Suitably, the liquefied stream that is to be heated is fed into one or more tubes 12 of the optional tube bundle 14. If the liquefied stream is at high pressure, it may be in a supercritical state wherein no phase transition takes place upon heating. Below the critical pressure, the liquefied stream may stay below its bubble point, or partially or fully vaporize in the one or more tubes 12, as it passes through the first heat transfer zone 10. The first heat exchange surface 11 is preferably arranged within the vapour zone 8 in the first heat transfer zone 10, above the nominal liquid level 7.

Preferably, the condensed portion of the heat transfer fluid 9 is allowed to accumulate in the first heat transfer zone 10 to form the liquid layer 6 of the heat transfer fluid 9 in the liquid phase. The condensed portion may drop from the first heat transfer surface 11, preferably above the nominal liquid level 7, into the liquid layer 6, possibly via the liquid diversion means such as one of the weir plates 25.

At the same time a part of the liquid heat exchange fluid 9 present in the liquid layer 6 flows into the downcomer 30. This forms part of the cycling of the heat transfer fluid 9 in the closed circuit 5. The liquid phase flows downward through the downcomer 30 and thermally insulated from the ambient, from the first heat transfer zone 10 via the downcomer 30 to the second heat transfer zone 20, and back to the first heat transfer zone 20. The flow rate of the heat transfer fluid through the downcomer 30, or preferably the relative flow rates through each branch 32 of the downcomer 30, is regulated by the valve 33.

In the second heat transfer zone 20 the heat transfer fluid 9 is indirectly heat exchanging with the ambient, whereby heat is passed from the ambient to the heat transfer fluid 9 and the heat transfer fluid 9 is vaporized. The optional fan 50 may be utilized to increase circulation of ambient air along the second heat transfer zone 20. The ambient air may traverse the second heat transfer zone 20 in a downward direction, as indicated in FIG. 1 by the arrows 52.

The heat transfer fluid 9 preferably rises upward during said vaporizing of the heat transfer fluid 9 in the second heat transfer zone 20. This rising upward may take place in the at least one riser tube 22, preferably in the plurality of riser tubes 22. In the latter case, the condensed portion leaving the downcomer 30 is preferably distributed over the plurality of riser tubes 22.

Preferably no vapour is generated and/or present inside the downcomer 30, as any vapour in the downcomer 30 may adversely affect the flow behaviour of the heat transfer fluid 9 inside the closed circuit 5. Especially when the cycling of the heat transfer fluid 9 through the closed circuit 5 is exclusively driven by gravity, it is advantageous to avoid any vapour in the downcomer 30. During each single pass of said cycling of the heat transfer fluid 9 in the closed circuit 5 the condensed portion in liquid phase preferably passes from the first heat transfer zone 10 to the downcomer 30 via the vortex breaker 60, which further helps to avoid access of vapour into the downcomer 30.

The person skilled in the art will understand that the present invention can be carried out in many various ways without departing from the scope of the appended claims.

1. A method of heating a liquefied stream, comprising:
passing the liquefied stream that is to be heated through a first heat transfer zone comprising a first box in the form of a shell that contains a heat transfer fluid, in indirect heat exchanging contact with the heat transfer fluid across a first heat transfer surface arranged inside the first box, whereby heat transfers from the heat transfer fluid to the liquefied stream, thereby condensing at least part of the heat transfer fluid to form a condensed portion;
allowing accumulation of a part of the condensed portion within the first box thereby forming a liquid layer of the heat transfer fluid in the liquid phase within the first box, wherein above the liquid layer of the heat transfer fluid in liquid phase within the first box is a vapour zone, whereby the first heat transfer surface is arranged within the vapour zone in the first box;
cycling the heat transfer fluid in a closed circuit from the first box via at least a downcomer to a second heat transfer zone and back to the first heat transfer zone, all arranged in an ambient;
wherein said cycling of the heat transfer fluid comprises drawing liquid from the liquid layer in the first box and passing said liquid from the liquid layer in liquid phase through the downcomer to the second heat transfer zone, and passing the heat transfer fluid through the second heat transfer zone to the first heat transfer zone, whereby in the second heat transfer zone indirectly heat exchanging with the ambient thereby passing heat from the ambient to the heat transfer fluid and vaporizing the heat transfer fluid, wherein the second heat transfer zone discharges into the vapour zone in first box at a location that is gravitationally above the liquid layer, wherein the heat transfer fluid from the second heat transfer zone passes through open ends of one or more riser end pieces as the heat transfer fluid is being discharged from the second heat transfer zone into the first box, which one or more riser end pieces traverse through the liquid layer into the vapour zone, whereby the open ends of the riser end pieces are located gravitationally lower than the first heat exchange surface.

2. The method of claim 1, wherein no vapour passes from the first box into the downcomer.

3. The method of claim 1, wherein maintaining a nominal liquid level of the liquid layer of heat transfer fluid accumulated within the first box.

4. The method according to claim 3, wherein an interface between the first heat transfer zone and the downcomer may be formed by a through opening in the shell of the first box, wherein the interface is located gravitationally lower than the nominal liquid level.

5. The method according to claim 3, wherein the open ends of the riser end pieces are located above the nominal liquid level.

6. The method according to claim 1, wherein said liquid from the liquid layer in liquid phase passes downward through the downcomer to the second heat transfer zone thermally insulated from the ambient.

7. The method according to claim 1, wherein each single pass of said cycling of the heat transfer fluid in the closed circuit, comprises passing the condensed portion in liquid phase from the first box to the downcomer via a vortex breaker.

8. The method according to claim 1, wherein the liquefied stream that is to be heated comprises liquefied natural gas and wherein a revaporized natural gas stream is produced by heating and thereby vaporizing said liquefied natural gas.

9. The method according to claim 1, further comprising shielding the riser end pieces from condensed heat exchange fluid falling down from the first heat exchange surface.

10. An apparatus for heating a liquefied stream, comprising a closed circuit for cycling a heat transfer fluid, the closed circuit comprising a first heat transfer zone, a second heat transfer zone, and a downcomer, all arranged in an ambient, wherein the first heat transfer zone comprises a first box in the form of a shell that contains the heat transfer fluid, wherein a first heat transfer surface is arranged inside the first box, across which first heat transfer surface a first indirect heat exchanging contact is established between a liquefied stream that is to be heated and the heat transfer fluid, said apparatus further comprising a liquid layer of the heat transfer fluid in the liquid within the first box wherein above the liquid layer of the heat transfer fluid in liquid phase within the first box is a vapour zone, whereby the first heat transfer surface is arranged within the vapour zone in the first box, wherein the second heat transfer zone is located gravitationally lower than the first heat transfer zone and where the second heat transfer zone comprises a second heat transfer surface across which the heat transfer fluid is brought in a second indirect heat exchanging contact with the ambient, and wherein the downcomer fluidly connects the first heat transfer zone with the second heat transfer zone, whereby an interface between the downcomer and the first box is located submerged under the liquid layer of the heat transfer fluid in the first box, wherein the second heat transfer zone comprises at least one riser tube fluidly connected to the first heat transfer zone, which at least one riser tube comprises a riser end piece fluidly connected to the riser tube and traversing through the liquid layer into the vapour zone, wherein an open end of the at least one riser tube is located gravitationally lower than the first heat exchange surface.

11. The apparatus according to claim 10, wherein the open end is located within the vapour zone.

12. The apparatus according to claim 10, further comprising a nominal liquid level of the liquid layer of heat transfer fluid accumulated within the first box, wherein an interface between the first heat transfer zone and the downcomer may be formed by a through opening in the shell of the first box, wherein the interface is located gravitationally lower than the nominal liquid level and/or wherein the open end of the at least one riser tube is located above the nominal liquid level.

13. The apparatus according to claim 10, wherein the downcomer is thermally insulated from the ambient.

14. The apparatus according to claim 10, wherein the downcomer has an upstream end for allowing passage of the heat transfer fluid from the first heat transfer zone into the downcomer, and a downstream end for allowing passage of the heat transfer fluid from the downcomer towards the second heat transfer zone, wherein a vortex breaker is provided at the upstream end of the downcomer.

15. The apparatus according to claim 10, further comprising one or more liquid diversion means arranged between the heat exchange surface and the open end of the at least one riser end piece.
